(19) United States
(12) Patent Application Publication
(10) Pub. No.: US 2005/0123113 A1
(43) Pub. Date: Jun. 9, 2005

(54) Internet lockout device

(76) Inventor: Douglas Horn, Framingham, MA (US)

Correspondence Address: WOOD, HERRON & EVANS, LLP, 2700 CAREW TOWER, 441 VINE STREET, CINCINNATI, OH, 45202, US

(21) Appl. No.: 10/730,840

(22) Filed: Dec. 9, 2003

(51) Int. Cl. H04M 1/66; H04M 11/00; H04L 9/00; H04L 9/32; G06F 11/30; G06F 12/14

(52) U.S. Cl. 379/199; 713/200; 379/93.02

(57) ABSTRACT

A lockout system for preventing a person from accessing electronic information through an interface device of a computer having a signal cable operably coupled at one end with a signal port and at the other end with an interface device of a computer, the signal cable configured to pass electronic information back and forth between the interface device and the port and a locking device including a relay having a set of contacts, the set of contacts coupled in-line with the signal cable, the relay when actuated, disabling the signal cable to prevent electronic information from passing between the interface device and the port. A plug lock insertable with the signal cable proximate the other end of the cable may be included for maintaining the other end of the signal cable in operable connection with the interface device to hinder a bypass of the lockout system.

### FIELD OF THE INVENTION

This invention relates generally to a system and method for preventing children from accessing parentally-restricted electronic information through their computers, and is specifically related to preventing children from accessing pornography and other undesirable information over the Internet, as well as limiting the amount of time a child has access to the Internet.

### BACKGROUND OF THE INVENTION

With the widespread access to on-line computer information and services, which continues to grow each year, collectively referred to as the Internet, computer users are able to obtain a wide variety of information, which is delivered directly into their homes. All that is necessary to access the Internet is a computer with a modem or interfacing capability, a telephone or digital subscriber line (DSL), and a telephone port or jack.

To meet the demand for Internet information, there has also been a proliferation of Internet services and access software packages which allow a user to move through or browse the available on-line options. This has made it very easy for users to obtain the information they need. Internet users are not only adults, but children as well, and ironically, children, as a class, are probably more computer literate than many adults due to the great amount of exposure to computers that children now receive at an early age. The user-friendly atmosphere of the Internet allows children with even minimal computer skills to access information at defined “sites” which are related to a particular topic.

Unfortunately, not all information sites contain material which is suitable for children. Pornographic material, for example, is abundant on the Internet, and children can access and view pornographic pictures much the same way that they might view pictures in a pornographic magazine. While access to magazines and other printed materials is limited to adults, access to Internet pornography is not so limited. As may be appreciated, child access to pornography through the Internet is an alarming concern for parents and other adults, such as educators, who do not want their own children or children in their care exposed to pornography.

Additionally, pornographic materials and sites are not the only informational avenues to which parents and other adults would like to restrict their children's access. The Internet also provides access to information regarding body piercing, child pornography, violent topics, and other similar information which would be detrimental to the proper mental and physical development of a child. Seemingly innocuous chat groups on the Internet may also expose a child to harmful adult topics. Chat groups are not only mentally dangerous to children but also physically dangerous, as evidenced by numerous incidences wherein children have been abducted by pedophiles who they have met and talked with over the Internet.

Therefore, parents and other adults have a substantial interest in preventing children from accessing the Internet through their computers. This is becoming ever more difficult, since personal and home computers are very popular and are becoming more widespread, much the same way that television did in the 1950's and 1960's. Parents' frustrations are further exacerbated by the fact that personal computers are usually placed in a home office, bedroom, or other designated room and are not readily visible to a supervising adult. A child may be accessing parentally-restricted information right under the nose of a parent.

While censorship efforts have been made to prevent certain categories of materials from appearing on or being accessible through the Internet, they have been generally unsuccessful. Despite the possible harm to children from these materials, First Amendment arguments and concerns have prevented the removal of the above-discussed material from the Internet. Furthermore, since adults and children share the same access to such materials, widespread database prevention for children at the source will inevitably prevent adult access to information which arguably should be available to them. Therefore, parents and other adults are left with the task of preventing children from accessing certain Internet materials.

Furthermore, not only are parents and adults interested in preventing Internet access to potentially damaging and harmful materials, but they are also interested in preventing any additional Internet access at all. Internet shopping is also a concern, as companies offer numerous products for sale over the Internet which require only a credit card number. In the case of some on-line services, they may already have the parent's credit card number and all that a child has to do is make the order. There are more than a few parents that have been unpleasantly surprised by credit card bills directly related to their child's access to the Internet. Finally, a parent may simply be interested in preventing a child from spending too much time on the computer to the detriment of their school work or other activities, such as sports. For example, with the use of messaging products, children may use the Internet to chat with one another, and a parent may desire to limit such chatting.

A simple solution to preventing a child's access to the Internet would be to remove the computer and lock it away until a child may be supervised by an adult. Such a solution is not only impractical, but it is also inconvenient. Computers are usually bulky and heavy and are not easy to move around. Furthermore, the various peripherals such as printers, monitors, and phone line connections will constantly have to be disconnected and then reconnected each time the computer is to be used. Still further, removing the computer prevents adult use and non-Internet use. Computers are very useful tools and are used by adults and children alike for a number of constructive tasks such as accounting, document generation, and homework. Locking the computer away prevents such constructive use. Even when the computer is to be constructively used, such as by a child for homework, most parents do not want to have to stand behind the child or even stay in the same room to prevent Internet access altogether or to prevent access to undesirable or adult materials.

One electronic information lockout device that prevents Internet access through a computer is disclosed in U.S. Pat. No. 5,661,786 (the '786 patent), held by the inventor of the present invention. Using this device, Internet access may be prevented using a keyed switch. Although the device of the '786 patent performs well, a user must be proximate the device and use the key to prevent Internet access. Moreover, a user must keep track of the physical location of the key. For these reasons, improvements related to the ability of preventing Internet access without being proximate a lockout device and requiring a key are in continuing need.

One electronic information lockout system that prevents Internet access through a computer is disclosed in U.S. Pat. No. 5,938,767 (the '767 patent), also held by the inventor of the present invention. Such a system comprises a controller unit and a locking device including a key operated switch. Although the system of the '767 patent performs well, again, due to the key, improvements related to the ability of preventing Internet access without being proximate a lockout device and requiring a key are in continuing need.

Therefore, it is an objective of the present invention to assist parents and other adults in preventing a child's exposure to harmful and undesirable information available on the Internet.

It is another objective of the invention to provide parents with the ability to limit the amount of time a child spends using the Internet.

It is still another objective of the invention to restrict unsupervised access to the Internet to reduce the monetary costs associated therewith.

It is another objective to provide to an adult such restrictive measures without substantial modification to or removal of a computer to allow constructive use of a computer by a child.

It is still another objective to provide assistance to adults in a relatively inexpensive and easily understood manner so that restrictive measures may be implemented without substantial financial or time expenditures by an adult.

It is another objective to restrict a child's access to the Internet in a way which is not easily or readily overcome or bypassed by the child.

It is still another objective to provide a parent the ability to restrict Internet access without knowing how to use a computer.

It is another objective to provide a parent with the ability to restrict Internet access remotely.

### SUMMARY OF THE INVENTION

The above objectives and other objectives are met by the lockout system of the present invention which prevents children from accessing parentally-restricted and undesirable electronic information through an interface device of a computer, while further allowing a parent to limit the amount of time a child has access. The lockout system prevents exposure to undesirable information while maintaining the operational integrity of the computer so that it may be used for constructive purposes. The lockout system is easy to use and may be installed without modification to the computer. The lockout system is not easily or readily bypassed by a child and provides a parent or other adult the ability to restrict Internet access without themselves intimately knowing how to use a computer.

More specifically, the lockout system of the invention comprises a locking device which is operably coupled in-line with a signal line, such as a telephone or digital subscriber line (DSL). The telephone line extends between a telephone jack and an interface device in the computer, such as a modem. The DSL extends between a telephone or cable jack and a cable/DSL modem external to the computer. The cable/DSL modem is then coupled to an interface device in the computer, such as an Ethernet port. The locking device is operable to decouple the modem card from the telephone jack or the computer from the cable/DSL modem. The locking device, when actuated, prevents electronic information from passing between the modem and the jack or the cable/DSL modem and the computer. In that way, children cannot gain access to on-line information through the Internet, when the locking device is actuated. Deactuating the locking device will provide the necessary connection between the modem and the telephone jack or the cable/DSL modem and the computer so that access to the Internet may be achieved by an adult or an adult-supervised child.

In one embodiment of the invention, the locking device is a keyed switch coupled to a relay which is mounted in-line with the signal line and which may be energized and de-energized using a key. The key is turned to open the switch and then removed thereby leaving the switch open, de-energizing the relay, and effectively breaking the electrical coupling between the modem card and telephone jack or the cable/DSL modem and the computer. Preferably, the keyed switch relay are contained within an enclosed case to prevent the child from physically bypassing the locking device.

In another embodiment of the invention, the locking device includes a lock controller coupled and configured to control the relay.

In yet another embodiment of the invention, a reading device may serve as an alternative to a keyed switch, the reading device also coupled to the lock controller.

In yet another embodiment of the invention, an interactive telephone component coupled to the lock controller allows a user to enable/disable Internet access using a telephone.

In yet another embodiment of the invention, a web based device coupled to the lock controller allows a user to enable/disable Internet access using a web-based interface.

In yet other embodiments of the invention, a display or lights indicate whether an Internet connection is enabled or disabled.

The lockout system of the invention thereby assists parents and other adults in preventing a child's exposure to harmful and undesirable on-line information and reduces or eliminates the costs that might be associated therewith. Further, the invention allows a parent to limit the amount of time a child has access to on-line information. The lockout system does not affect the stand-alone operational capability of the computer and only prevents access to information through a telephone line or DSL. The lockout system may be installed quickly and easily without modification to the computer equipment. Furthermore, the lockout system does not require the adult to be able to operate the computer. The lockout system is not easily or readily overcome or bypassed by the child without blocking or ruining the modem or alerting an adult that a bypass attempt is underway so that it may be stopped.

While the lockout system of the present invention is preferably directed to computer modem use and telephone line access and/or cable/DSL modem and DSL access, it will be readily understood that other interface devices and signal capabilities might be utilized as well, and the lockout system is equally applicable to those technologies wherein access to on-line services is provided through a computer-based interface device. For example, on-line access utilizing ISDN cards, cable cards, asynchronous transfer mode (ATMs), dial-up modems, cable modems, asymmetric digital subscriber lines (ADSLs), or satellites might also be prevented utilizing the present invention. Further, the lockout system of the present invention may be used with technologies such as WebTV, televisions and cable boxes with Internet capabilities, or other computer systems capable of providing on-line services.

The objectives and benefits of the present invention will become more readily apparent from the brief description of the drawings and detailed description of the invention given below.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of the lockout system of the invention coupled between a computer and a telephone jack;

FIG. 2 is a perspective view of the lockout system of the invention coupled between a computer and a cable/digital subscriber line (DSL) modem;

FIG. 3 is a schematic view of an embodiment of a locking device for the lockout system for the invention;

FIG. 4 is a block diagram for a lockout system including a reading device and a display;

FIG. 5 is a flowchart illustrating the program flow of a process of authenticating and authorizing a user in the lockout system of FIG. 4;

FIG. 6 is a block diagram for a lockout system including a reading device, a display, and an interactive telephone component;

FIG. 7 is a flowchart illustrating the program flow of a process of verifying a user and enabling/disabling Internet access using interactive telephone component of the lockout system of FIG. 6;

FIG. 8 is a block diagram for a lockout system including a reading device, a display, and a web-based interface; and,

FIG. 9 is a flowchart illustrating the program flow of a process of verifying a user and enabling/disabling Internet access using a web-based device of the lockout system of FIG. 8 is illustrated.

### DETAILED DESCRIPTION OF SPECIFIC EMBODIMENTS

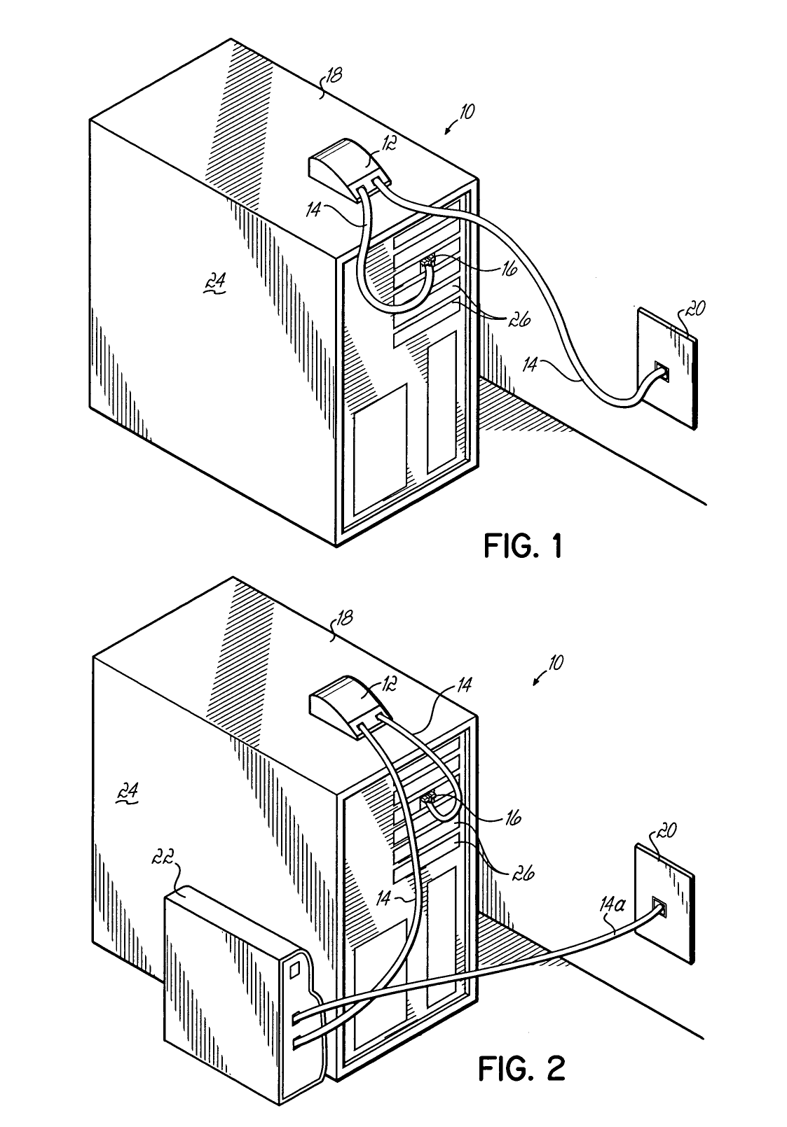

With reference to FIGS. 1 and 2, there is shown one embodiment 10 of a lockout system in accordance with principles of the present invention. Lockout system 10 comprises a locking device 12, a telephone cable 14 (a portion 14a of which may be a coaxial cable, as shown in FIG. 2), and a plug lock 16. As shown in FIG. 1, lockout system 10 may be installed between a computer 18 and a signal port, such as telephone jack 20. As shown in FIG. 2, lockout system 10 may also be installed between a computer 18 and a cable/digital subscriber line (DSL) modem 22. In either installation, when the locking device 12 is actuated, Internet access is prevented.

As will be appreciated by those of skill in the art, lockout system 10 may also be installed between a cable/DSL modem and a router such that Internet access by multiple computers coupled to the router may be prevented. In such an installation, a plug lock 16 would be installed on the cable/DSL modem, rather than on each individual computer, as shown in FIGS. 1 and 2.

Computer 18 may be any suitable computer device, such as a personal computer, which utilizes a modem or network card for access to remote information sites, such as the Internet. Generally, such personal computers include an outer metal or plastic case 24 which surrounds the electronics of the computer. The case 24 will generally stand alone (as shown) or will provide a base for mounting other equipment, such as a monitor (not shown). Case 24 may include a plurality of slotted openings 26 generally located at a rearward side thereof. Such slotted openings 26 generally correspond to card slots which are located inside the computer and are configured to receive interface cards, such as a modem card for providing telephone line communication or a network card for connecting the computer 18 to communicate with cable/DSL modem 22. Those skilled in the art will also appreciate that interface cards, such as a modem or network card, may be incorporated onto the motherboard of a computer, in which case, slotted openings 26 may or may not be provided.

The lockout system 10 of the present invention will be described herein for being used with a modem card, or between a telephone modem in a computer and a telephone wall jack, as shown in FIG. 1. Likewise, and as shown in FIG. 2, lockout system 10 of the present invention will also be described herein for being used with a network card, or between an Ethernet card in a computer and a cable/DSL modem. However, it should be understood that the lockout system will be equally applicable for other interface cards such as ISDN cards, cable cards, asynchronous transfer mode (ATM) cards, dial-up modems, cable modems, asymmetric digital subscriber lines (ADSLs), and satellite modems both internal and external to a computer to generally prevent unauthorized access to parentally-restricted electronic information. It should be further understood that the lockout system may be used with technologies such as WebTV, televisions and cable boxes with built-in Internet capabilities, and other computer systems capable of providing on-line services.

The telephone jack 20 is a conventional jack used for telephone communication or data transfer in a computer network. Other signal ports might be utilized depending upon the interface device and the communication scheme as appropriate.

The present invention operates by decoupling computer 18 from the telephone jack 20 using locking device 12 and effectively preventing bypassing of the locking device 12 by a child.

More specifically, plug lock 16, described in U.S. Pat. No. 5,556,295 to McFadden et al. and entitled “Modular Plug Locking System,” the disclosure of which is fully incorporated herein by reference, may be used to prevent a child from unplugging telephone cable 14 and bypassing lockout device 12. In the alternative, a clamp may be substituted for plug lock 16. U.S. Pat. No. 4,647,726 to Blum, entitled “Telephone Security Clamp,” describes such a clamp, the disclosure of which is also fully incorporated herein by reference. Irrespective of whether a plug lock 16 or a clamp is used, those skilled in the art will appreciate that the primary goal of such a plug lock or clamp is to secure a telephone cable to the computer, thereby preventing a child from bypassing locking device 12.

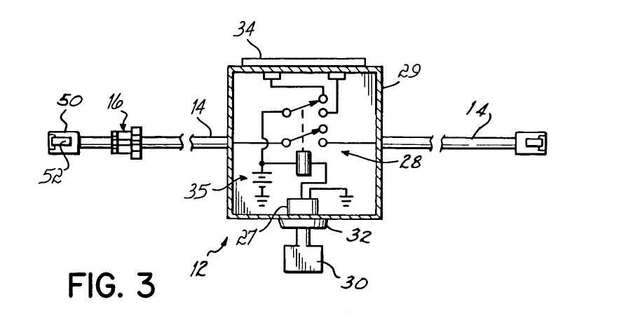

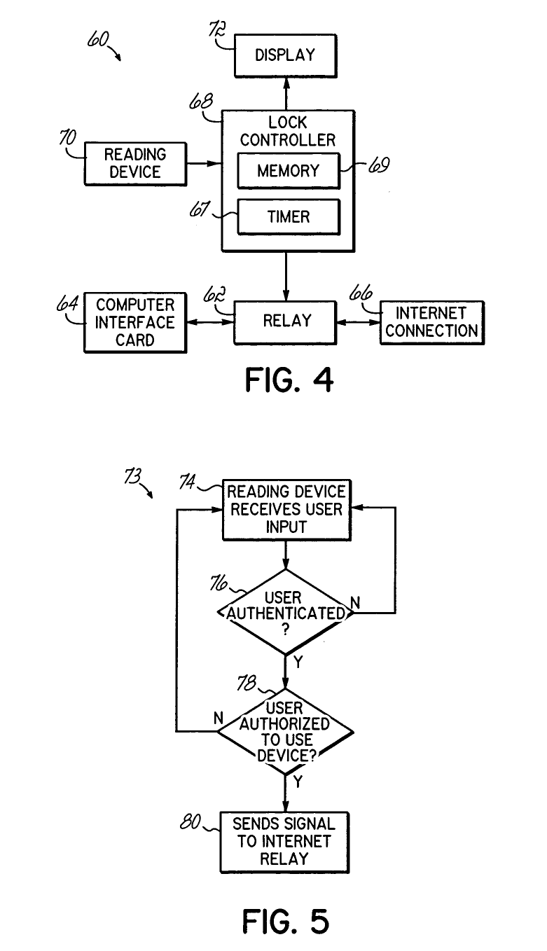

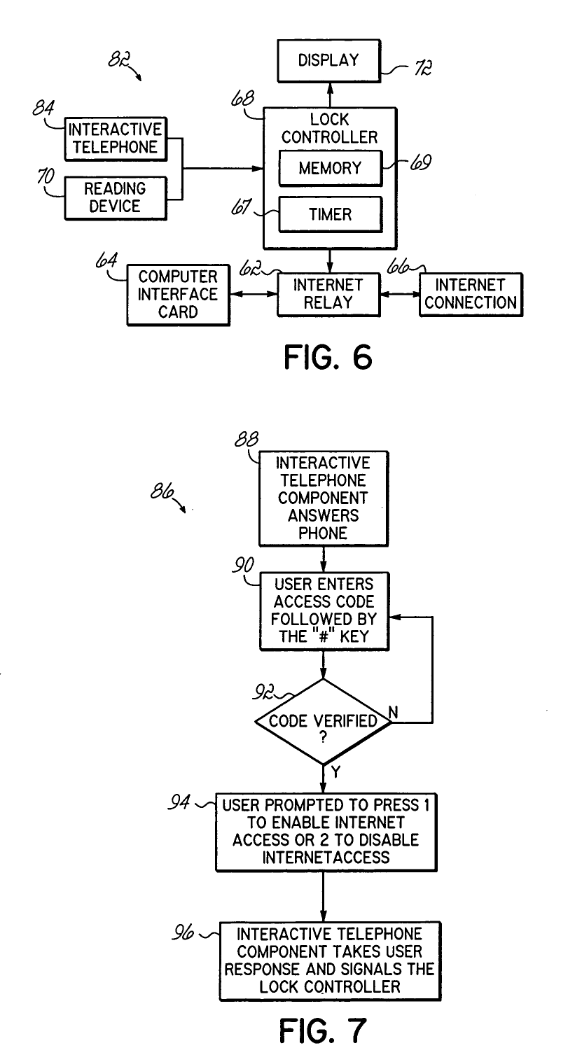

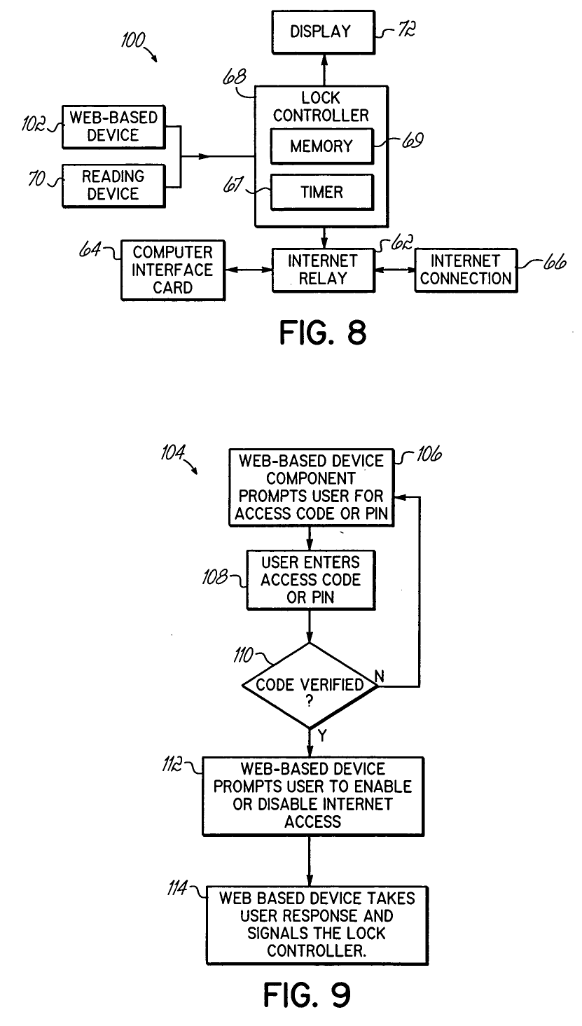

Moreover, in one embodiment of the invention a locking device includes a key controlled relay and a display that indicates the status of the locking device. FIG. 3 shows a schematic for such an embodiment. In another embodiment of the invention, a locking device includes a reading device and display. FIG. 4 shows a block diagram for a locking device including a reading device and a display. In yet other embodiments of the invention, a locking device includes a reading device and indicator lights as well as an interactive telephone component or a web-based device. FIGS. 6 and 8 show block diagrams for the operation of two embodiments of a locking device including an interactive telephone component and a web-based device, respectively.

Referring now to FIG. 3, one embodiment of the locking device is schematically illustrated wherein a relay 28 coupled to a key-operated switch or keyed switch 27, is utilized for actuation and deactuation of the locking device 12. One set of contacts of relay 28 is coupled in-line with telephone cable 14 and is opened and closed by turning an inserted key 30 in keyhole 32 thereby energizing and de-energizing the relay 28. The relay 28 is operable such that when the switch is open, the relay is de-energized and the cable is effectively opened and disabled. The key may then be removed so that a parent or other adult can keep it in a safe place away from a child. Thus, when relay 28 is de-energized, cable 14 is disabled and no communication can take place therethrough. To enable the cable 14, the key is inserted and turned to close the switch 27, energizing the relay 28. Another set of contacts of relay 28 is coupled to display 34, indicating the whether the locking device 12 is activated or deactivated.

As will be understood by a person of ordinary skill in the art, the relay may be arranged so that opening the switch enables the cable and closing the switch disables the cable.

As shown in FIG. 3, power source 35 is controlled by keyed switch 27 to energize relay 28. Further, power source 35 may be mounted internal to case 29, as also shown in FIG. 3. It will be understood that a power source may also be external to an enclosure or case in some embodiments of the invention. Moreover, in some embodiments of the invention a power source may be provided by or taken from cable 14.

Thus, by using a relay in a locking device to open and close an Internet connection, a switch, such as switch 27, may be a single-pull single-throw (SPST) switch rather than a double-pull double-throw (DPDT) switch that itself opens and closes the Internet connection. The use of a SPST switch rather than a DPDT switch reduces the cost of a locking device. The use of a relay also facilitates the inclusion of a display. A display allows a parent to easily see whether the Internet is enabled or disabled from across a room, potentially eliminating the need to stand directly behind a child while the child is using the computer.

Telephone cable 14 may have any number of wire conductors for carrying the necessary communication signals. A typical telephone line would have four conductors. Relay 28 may be effectively coupled in-line with telephone cable 14 by routing at least one of the operative conductors through the relay while allowing one or more of the other operative conductors to be unswitched. Alternatively, all of the conductors of cable 14 might be operably coupled through the relay 28. Therefore, Internet access may be prevented by using key 30. An adult does not have to have any particular computer knowledge to use the locking device. As mentioned, the locking device may be deactuated by using key 30 to close switch 27, energize the relay 28, and thereby enable telephone cable 14.

The lockout system 10 of the present invention is easy to install and may not be readily bypassed by a child. Referring to FIGS. 1-3, a preferred embodiment of plug lock 16 is illustrated. As shown in FIGS. 1 and 2, plug lock 16 is inserted with plug 50 and prevents cable 14 from being unplugged from the modem or network card of a computer. More specifically, and as shown in FIG. 3, plug lock 16 prevents access to tab 52 thereby preventing removal of plug 50 from the modem or network card.

If any attempt is made to physically remove plug 50 from the modem or network card, the use of plug lock 16 and its insertion with plug 50 will maintain the plug in the modem or network card and will only allow removal of the cable 14, leaving plug 50 inserted. In that case, the modem or network card will essentially be blocked from receiving another plug and Internet access will be prevented. Moreover, cable 14 or plug lock 16 will likely be damaged, indicating to a parent that the child was attempting to bypass lockout system 10.

Still referring to FIG. 3, the keyed switch 27 is preferably surrounded by a rigid case which prevents tampering with the locking device 12. Preferably, the case 29 will be a metal or rigid plastic which is factory sealed so that the only way to access the internal parts of the locking device will be to break or cut the case 29. Again, such destruction of the case will also be a visual indication for an adult that the child is trying to bypass the lockout system 10.

The lockout system 10 of the invention provides an inexpensive and easy-to-use tool for preventing unauthorized access to electronic information through on-line services. The locking device 12 of the invention may be actuated and deactuated, or locked and unlocked, as necessary to prevent Internet access or to provide adult supervised access. The lockout system does not affect the stand-alone operational capability of the computer, and therefore, a child may use the computer for other constructive tasks. The lockout system might be installed quickly and easily without a substantial modification to the computer equipment and the operation of the lockout system does not require that the adult be able to actually operate the computer. This is a particular advantage of the invention, as some adults will want to supervise their children without having to become computer experts themselves. Furthermore, the lockout system of the invention is not easily or readily overcome or bypassed by a child without ruining the cable or alerting an adult that a bypass attempt is underway so that it may be stopped.

The remaining embodiments of the present invention, shown in FIGS. 4-9 and described herein after, include various features described in conjunction with lockout system 10 shown in FIGS. 1-3. Moreover, the embodiments shown in FIGS. 4-9 provide additional or alternative features with still further benefits. For example, FIG. 4 shows a block diagram for a lockout system including a reading device and a display, while FIGS. 6 and 8 show a block diagram for two embodiments of lockout systems including an interactive telephone component and a web-based device, respectively.

Referring now to FIG. 4, a block diagram for lockout system 60 is illustrated. Lockout system 60 comprises a relay 62, a lock controller 68, a reading device 70, and a display 72. Relay 62, lock controller 68, reading device 70, and display 72 may be mounted in an enclosure or case, such as case 24 shown in FIG. 3.

As described above, relay 62 is coupled intermediate a computer interface card 64 and an Internet connection 66, and configured to enable/disable Internet access. Again, a computer interface card may be a telephone modem, an Ethernet card, an internal cable or ADSL modem, a USB or Firewire port, or other yet unknown computer interfaces. Similarly, an Internet connection may be a telephone wall jack, an external cable/DSL modem, a satellite dish system, or any yet unknown Internet connection.

Generally, relay 62 is coupled to and controlled by lock controller 68. Lock controller 68 energizes/de-energizes relay 62 in response to reading device 70. The Internet status, or whether Internet access is enable/disable, is indicated by display 72.

A reading device 70 may be any one of many reading devices known to those of skill in the art. A reading device may be a magnetic card reader, a numeric or alphanumeric keypad, a keyboard, a touch screen, a fingerprint or retinal scanner, or a voice or facial recognition device. A reading device is generally used to authenticate, or provide a user identity, and grant Internet access based thereon.

Lock controller 68 includes a processor, or microprocessor, preferably including a timer 67 and memory 69. In addition to controlling relay 62, lock controller 68 is configured to store authentication information, e.g., magnetic card personal identification numbers (PINs), images of finger prints, etc., using included memory 69, to which information presented through reading device 70 is then compared. Lock controller may be further configured to assign temporary authentication for a fixed amount of time using included timer 67. For example, a babysitter could be assigned a temporary access code for the night that the babysitter is to watch a child, thereby limiting access to the Internet for that particular evening. Moreover, timer 67 provides the ability to limit the amount of time that a child has access to the Internet. For example, lockout device 60 may limit one child's Internet access to one hour per day, while limiting another child to two hours per day. Timer 67 may also be used to provide Internet access only during specified times during weekdays, while providing different access times during weekends. For example, Internet access may be enabled between the hours of 7:00 pm and 8:30 pm, Monday through Friday, and 9:00 am and 11:00 am, Saturday and Sunday. Other uses of a timer for enabling Internet access will be understood by those skilled in the art.

Those skilled in the art will also appreciate that a processor may be replaced with specialized circuitry capable of performing like tasks. Despite incurring time and expense, such a replacement would not constitute a departure from the spirit of the present invention.

Display 72 in its simplest form may utilize indicator lights or light-emitting diodes (LEDs). Indicator lights or LEDs may be coupled to lock controller 68 and alternately illuminated to indicated whether Internet access is enabled or disabled. In other embodiments of the invention a display may be a liquid crystal display (LCD). In still other embodiments of the invention a display may be a video screen, such as those commonly used in cellular telephones. In addition to indicating whether Internet access is enabled or disabled, a LCD and a video screen are particularly advantageous in a lockout system 60 in setting the system to limit access to the Internet based on user, time, day of week, etc., as described herein above.

In operation, a person or user wishing to enable access to the Internet would interact with reading device 70, entering a PIN through a keypad, passing an access card through a magnetic card reader, etc. The reading device 70 then passes information, e.g., PIN, magnetic code, etc., to lock controller 68. Lock controller 68 then authenticates the user. Next, lock controller authorizes the user. If the user is authenticated and authorized, lock controller 68 either energizes or de-energizes relay 68 to either enable or disable Internet access. Lock controller 68 then displays whether the Internet is enabled or disabled on display 72.

Referring now to FIG. 5, a flowchart illustrating the program flow of a process of authenticating and authorizing a user in the lockout system of FIG. 4 is illustrated. Process 73 begins in step 74 wherein a user enters a PIN through a keypad, passes an access card through a magnetic card reader, etc. using reading device 70. This PIN, magnetic code, etc., is compared or verified against information stored in memory 69 by lock controller 68 to authenticate or identify the user in step 76. If the user is authenticated, step 78 is entered. Otherwise, control is returned to step 74, and the process awaits further entry from a user while display 72 indicates an authenticating and/or authorizing failure to the user.

In step 78, lock controller 78 makes a comparison against information stored in memory 69 to ascertain whether the authenticated user is authorized at the current time, such as by using timer 67. For example, if a user is a parent, the parent might be authorized to use the Internet at all times. However, if the authenticated user is child, there may be some time restriction or limits on Internet access.

Once, the user is authorized, lock controller 68 sends a signal to relay 62 to enable or disable Internet access, in step 80. In some embodiments of the present invention, a display may also be updated in this step to indicate whether the Internet is enabled or disabled. However, if at the current time, the user is not authorized, control is returned to step 74 until such time as the user is authorized.

As another example, lockout system may comprise a keypad. A parent might enter a master code using the keypad, assigning a new code to a babysitter, authorizing that code, or the babysitter for some time period, such as the evening the babysitter is to watch a child. In this example, the babysitter would enter the new code via the keypad to use the Internet, and only be able to use the Internet during the evening the babysitter is to watch the child.

As yet another example, a lockout system may comprise a video display, wherein a lock controller 68 is configured to, display menu-driven options thereon. Such a video display has the benefit of allowing additional information to be provided to a user. For example, if a child is only allowed to use the Internet for one hour each day, the video display may indicate to the child the time that they have remaining to use the Internet.

Thus, process 73 provides a way of authenticating and authorizing a user of a lockout system.

Referring now to FIG. 6, a block diagram for lockout system 82 is illustrated. Like lockout system 60, shown in FIG. 4, lockout system 82 comprises relay 62, lock controller 68, reading device 70, and display 72. Further, lockout system 82 operates in a generally similar manner as lockout system 60, relay 62 being coupled intermediate a computer interface card 64 and an Internet connection 66, and configured to enable/disable Internet access.

Lockout system 82 further comprises an interactive telephone component 84. Interactive telephone component 84 allows a user to control lockout system 82 remotely over a telephone line, such as one available through cable 14 shown in FIG. 1. Further, interactive telephone component 84 allows a user to access lockout system 82 in much the same way one typically accesses an interactive telephone voice mail system. Generally, interactive telephone component prompts a user to enter an access or PIN code via a telephone keypad. Once the access code is verified, the user may then program lockout device 82 through a menu-driven system similar to most interactive telephone response systems, including enabling/disabling Internet access.

Referring now to FIG. 7, a flowchart illustrating the program flow of a process of verifying a user and enabling/disabling Internet access using interactive telephone component 84 of lockout system 82 of FIG. 6 is illustrated. Process 86 begins in step 88 wherein a user dials interactive telephone component 84 and interactive telephone component 84 answers the call.

Next, in step 90, interactive telephone component 84 prompts the user to enter an access code or PIN, followed by, for example, the “#” key. In step 92, interactive telephone component 84 verifies the access code through lock controller 68, through a comparison with information stored in memory 69. If the access code is verified, control is passed to step 94. Otherwise, control is returned to step 90, and the user is again prompted to enter an access code.

In step 94, the user is prompted to press “1” to enable Internet access or “2” to disable Internet access. In step 96, based on this selection of “1” or “2,” interactive telephone component 84 signals lock controller 68 to indicating to lock controller 68 whether to enable or disable Internet access using relay 62.

Thus, process 86 provides a way of remotely enabling/disabling Internet access using a lockout system and a telephone. Those skilled in the art will appreciate that an interactive telephone component may use voice-prompting as an alternative to key-entry, and that such a use does not constitute a departure from the spirit of the present invention. Further, a similar process may be used to remotely enable/disable Internet access based upon times, or to set up timed access. It will also be appreciated that such a process may be executed by lock controller, such as lock controller 68, rather than an interactive telephone component, and that such an incorporation also does not constitute a departure from the spirit of the present invention. Finally, those skilled in the art will also appreciate that a similar process may be used to select other menu selections and/or settings, such as will be described herein after.

Referring now to FIG. 8, a block diagram for lockout system 100 is illustrated. Like lockout systems 60 and 82, shown in FIGS. 4 and 6, respectively, lockout system 100 comprises relay 62, lock controller 68, reading device 70, and display 72. Further, lockout system 100 is configured like and operates generally similar to lockout systems 60 and 82, relay 62 being coupled intermediate a computer interface card 64 and an Internet connection 66, and configured to enable/disable Internet access.

Lockout system 100 further comprises a web-based device 102. Web-based device 102 provides a user the ability to configure lockout device 100 using an Internet browser, e.g., Microsoft Internet Explorer, Netscape Navigator, etc., either remotely or locally by entering the uniform resource locator (URL) or IP address of the lockout system.

Even though an Internet or web browser is suggested by this embodiment, those skilled in the art will appreciate that a lockout system may also be locally or remotely accessed over a network using other technologies. In such a networked application, a user may enter the network address for the lockout system. For example, in a “smart home,” a remote touch pad may allow a user to configure a lockout device. Similarly, an application on a computer or wireless device, such a cellular phone, palm, hand-held computer, etc., may allow a user to configure a lockout device.

For example, lockout device 100 may be configured locally using a computer through which that computer is coupled to the Internet, such as using computer 18 shown in FIG. 1. Alternatively, lockout device 100 may be accessed and configured through a network or Internet connection using some computer remote to lockout system 100.

Irrespectively of whether lockout system 100 is accessed and configured locally or remotely, a user would see a web-like screen on the browser used that would allow them to configure lock controller 68 or system 100. It will be understood that a network may be either wired or wireless.

Referring now to FIG. 9, a flowchart illustrating the program flow of a process of verifying a user and enabling/disabling Internet access using web-based device 102 of lockout system 100 of FIG. 8 is illustrated. Process 104 begins in step 106 wherein a user enters the network address of the lockout system using an Internet browser and a web-like screen appears to prompt the user to enter an access code or PIN. Next, and as reflected in step 108, the user enters the access code or PIN, perhaps also entering a carriage return or pressing a login button.

Next, in step 110, web-based device 102 verifies the access code through lock controller 68, through a comparison with information stored in memory 69. If the access code is verified, control is passed to step 112. Otherwise, control is returned to step 106, and the user is again prompted to enter an access code.

In step 112, web-based device 102 prompts the user to enable or disable Internet access. In step 114, and based on a selection by the user, web-based device 102 signals lock controller 68 to either enable or disable Internet access using relay 62, based on the user selection.

Thus, process 104 provides a way of locally or remotely configuring a lockout system to enabling/disabling Internet access using a web-based interface. Those skilled in the art will appreciate that in other embodiments of the present invention, such a process may also be incorporated into a lock controller, such as lock controller 68, shown in FIG. 6.

Those skilled in the art will also appreciate that similar programming may be used such that a local or remote user may set timer information. For example, the user may enter start and stop times for enabling Internet access or assign PINs, etc.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicant's general inventive concept.

1. A lockout system for preventing a person from accessing electronic information through an interface device of a computer comprising:
a signal cable configured for being operably coupled at one end with a signal port and at the other end with an interface device of a computer, the signal cable configured to pass electronic information back and forth between the interface device and the port;
a locking device including a relay having a set of contacts, the set of contacts coupled in-line with the signal cable, the relay when actuated, disabling the signal cable to prevent electronic information from passing between the interface device and the port;
a plug lock insertable with the signal cable proximate said other end, the plug lock configured for maintaining the other end of the signal cable in operable connection with the interface device to hinder a bypass of the lockout system.

2. The lockout system of claim 1 wherein the signal cable is a telephone cable operable for carrying modem signals and is configured for being connected between a telephone port and a modem to prevent access to prohibited information over a phone line.

3. The lockout system of claim 1 wherein the signal cable is a telephone cable operable for carrying network signals and is configured for being connected between a telephone port and a cable/digital subscriber line modem to prevent access to prohibited information over a digital subscriber line.

4. The lockout system of claim 1 wherein the locking device includes a keyed switch coupled to the relay which is opened and closed using a key structure, the switch energizing and de-energizing the relay thereby disabling and enabling the signal cable.

5. The lockout system of claim 4 wherein the locking device includes an outer housing, a portion of the keyed switch being located inside of said housing to further hinder a child from bypassing the lockout system.

6. The lockout system of claim 5 wherein the relay has a second set of contacts and the locking device further comprises a display coupled to the second set of contacts, the display indicating whether electronic information may pass between the interface device and the port.

7. The lockout system of claim 1 wherein the locking device includes a processor coupled to the relay, the processor configured to selectively energize and de-energize the relay thereby disabling and enabling the signal cable.

8. The lockout system of claim 7 wherein the locking device includes a display coupled to the processor for indicating whether the signal cable is enabled or disabled.

9. The lockout system of claim 7 wherein the locking device includes a reading device coupled to the processor, the processor configured to energize and de-energize the relay in response to input received through the reading device.

10. The lockout system of claim 9 wherein the reading device is a magnetic card reader.

11. The lockout system of claim 9 wherein the reading device is a keypad.

12. The lockout system of claim 9 wherein the reading device is a touch screen.

13. The lockout system of claim 9 wherein the processor includes a memory, the processor is configured to store user authentication information, compare the input received through the reading device to the store user authentication information, and energize and de-energize the relay in response to the comparison.

14. The lockout system of claim 13 wherein the processor includes a timer and the processor is configured to limit the amount of time a user has access to electronic information.

15. The lockout system of claim 14 wherein the locking device includes an interactive telephone component coupled to the processor, the interactive telephone component configured to allow a user to disable and enable the signal cable remotely.

16. The lockout system of claim 15 wherein the locking device includes a web-based device coupled to the processor, the web-based device to allow a user to disable and enable the signal cable using a computer.

17. A lockout system for preventing a person from accessing electronic information through an interface device of a computer comprising:
a signal cable configured for being operably coupled at one end with a signal port and at the other end with an interface device of a computer, the signal cable configured to pass electronic information back and forth between the interface device and the port;
a locking device including a relay having a set of contacts, the set of contacts coupled in-line with the signal cable, the relay when actuated, disabling the signal cable to prevent electronic information from passing between the interface device and the port.

18. The lockout system of claim 17 wherein the signal cable is a telephone cable operable for carrying modem signals and is configured for being connected between a telephone port and a modem to prevent access to prohibited information over a phone line.

19. The lockout system of claim 17 wherein the signal cable is a telephone cable operable for carrying network signals and is configured for being connected between a telephone port and a cable/digital subscriber line modem to prevent access to prohibited information over a digital subscriber line.

20. The lockout system of claim 17 wherein the locking device includes a keyed switch coupled to the relay which is opened and closed using a key structure, the switch energizing and de-energizing the relay thereby disabling and enabling the signal cable.

21. The lockout system of claim 20 wherein the locking device includes an outer housing, a portion of the keyed switch being located inside of said housing to further hinder a child from bypassing the lockout system.

22. The lockout system of claim 21 wherein the relay has a second set of contacts and the locking device further comprises a display coupled to the second set of contacts, the display indicating whether electronic information may pass between the interface device and the port.

23. The lockout system of claim 17 wherein the locking device includes a processor coupled to the relay, the processor configured to selectively energize and de-energize the relay thereby disabling and enabling the signal cable.

24. The lockout system of claim 23 wherein the locking device includes a display coupled to the processor for indicating whether the signal cable is enabled or disabled.

25. The lockout system of claim 23 wherein the locking device includes a reading device coupled to the processor, the processor configured to energize and de-energize the relay in response to input received through the reading device.

26. The lockout system of claim 25 wherein the reading device is a magnetic card reader.

27. The lockout system of claim 25 wherein the reading device is a keypad.

28. The lockout system of claim 25 wherein the reading device is a touch screen.

29. The lockout system of claim 25 wherein the processor includes a memory, the processor is configured to store user authentication information, compare the input received through the reading device to the store user authentication information, and energize and de-energize the relay in response to the comparison.

30. The lockout system of claim 29 wherein the processor includes a timer and the processor is configured to limit the amount of time a user has access to electronic information.

31. The lockout system of claim 30 wherein the locking device includes an interactive telephone component coupled to the processor, the interactive telephone component configured to allow a user to disable and enable the signal cable remotely.

32. The lockout system of claim 30 wherein the locking device includes a web-based device coupled to the processor, the web-based device to allow a user to disable and enable the signal cable using a computer.
